(19) United States
(12) Patent Application Publication
(10) Pub. No.: US 2008/0006359 A1
(43) Pub. Date: Jan. 10, 2008

(54) Runflat tire

(75) Inventor: Fumikazu Yamashita, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/819,143

(22) Filed: Jun. 25, 2007

(30) Foreign Application Priority Data
Jun. 26, 2006 (JP) 2006-175680

(51) Int. Cl. B60C 17/04

(52) U.S. Cl. 152/517

(57) ABSTRACT

A self-supporting runflat tire comprises; a carcass consisting of a single ply of organic fiber cords extending between bead portions and turned up around a bead core in each of the bead portions from the inside to the outside of the tire to form a pair of carcass ply turnup portions and a carcass ply main portion therebetween; a belt disposed radially outside a crown portion of the carcass; a sidewall reinforcing rubber layer disposed inside the carcass in the said sidewall portion and having a crescent-shaped cross sectional shape; a sidewall reinforcing cord layer of aramid cords disposed in the sidewall portion along the axially outer surface of the carcass ply main portion; and the carcass ply turnup portion extending radially outwardly beyond a maximum section width point of the carcass and terminated before the axial edge of the belt. Preferably, the aramid cord has a cord structure of 800 to 2200 dtex/2 and a twist number of from 30 to 70 turn/10 cm cord length. The cord count is 35 to 65 ends/5 cm.

### BACKGROUND OF THE INVENTION

The present invention relates to a runflat tire, more particularly to a self-supporting runflat tire having stiff sidewalls improved in the resistance to pinch cut during runflat operation.

In recent years, self-supporting runflat tires become commonplace for passenger cars, sport-utility vehicles, light trucks and the like.

In such self-supporting runflat tires, in order that the sidewalls can bear the weight of the vehicle even when the tire pressure is greatly reduced, the sidewalls are each provided with a relatively thick additional rubber layer to prevent the sidewall from folding or creasing, for example as disclosed in U.S. Pat. Nos. 5,058,646 and 6,237,661 and U.P. Patent application publication Nos. 2002/0014295 and 2002/0056499. Nowadays, it becomes possible to drive the vehicle continuously at a relatively high speed up to about 60-80 km/h for a relatively long distance of 70-80 km or more.

Such additional rubber layer, however, inevitably increases the tire weight. Therefore, in view of vehicles' fuel consumption, dynamic performance and the like under normal running conditions, the increase in the tire weight should be minimized as much as possible.

On the other hand, along with the popularization of such self-supporting runflat tires, vehicles equipped with self-supporting runflat tires have increased opportunity to run on uneven roads.

The above-mentioned excellent runflat performance can be obtained when running on well-paved roads, in other words, when the load of the tire is shared equally between the two sidewalls. However, when running on uneven roads especially unpaved roads, the runflat performance is very likely to deteriorate. As shown in FIG. 9, during running on the uneven road with a greatly reduced tire pressure or zero pressure, if one of the sidewalls is pushed up by a protrusion or an object on the road, the tire load concentrates on one sidewall, and the sidewall is largely folded. Since the additional rubber layer which resists to the compressive stress is disposed inside the carcass, a very large tensile stress is caused on the carcass cords and the axially outer sidewall rubber in the ground contacting patch. Thus, in the worst case, the carcass cords and/or axially outer sidewall rubber are broken.

If the additional rubber layer in the sidewall portion is decreased in the volume in order to decrease the tire weight, such breakage of the carcass cords and/or sidewall rubber (hereinafter, the “pinch cut”) becomes more likely to occur.

### SUMMARY OF THE INVENTION

It is therefore, an object of the present invention to provide a self-supporting runflat tire in which the resistance to pinch cut is improved while minimizing the increase in the tire weight due to additional load-supporting construction.

According to the present invention, a runflat tire comprises

a tread portion,

a pair of sidewall portions,

a pair of bead portions each with a bead core therein,

a carcass extending between the bead portions through the tread portion and sidewall portions, a belt disposed radially outside a crown portion of the carcass,

a sidewall reinforcing rubber layer disposed inside the carcass in each of the sidewall portions and having a crescent-shaped cross sectional shape, wherein

the carcass consists of a single ply of organic fiber cords extending between the bead portions and turned up around the bead core in each of the bead portions from the inside to the outside of the tire to form a pair of carcass ply turnup portions and a carcass ply main portion therebetween,

a sidewall reinforcing cord layer of aramid cords is disposed in each of the sidewall portions along the axially outer surface of the carcass ply main portion, and

the carcass ply turnup portions each extend radially outwardly beyond a maximum section width point of the carcass and terminates before the axial edge of the belt.

In the following description, the dimensions, sizes, positions and the like of the tire refer to those under the normally inflated unloaded condition unless otherwise noted.

The normally inflated unloaded condition is such that the tire is mounted on a standard wheel rim J and inflate to a standard pressure but loaded with no tire load.

The normally inflated loaded condition is such that the tire is mounted on the standard wheel rim and inflate to the standard pressure and loaded with the standard tire load.

The standard wheel rim is a wheel rim officially approved for the tire by standard organization, i.e. JATMA (Japan and Asia), T&RA (North America), ETRTO (Europe), STRO (Scandinavia) and the like. The standard pressure and the standard tire load are the maximum air pressure and the maximum tire load for the tire specified by the same organization in the Air-pressure/Maximum-load Table or similar list. For example, the standard wheel rim is the “standard rim” specified in JATMA, the “Measuring Rim” in ETRTO, the “Design Rim” in TRA or the like. The standard pressure is the “maximum air pressure” in JATMA, the “Inflation Pressure” in ETRTO, the maximum pressure given in the “Tire Load Limits at Various Cold Inflation Pressures” table in TRA or the like. The standard load is the “maximum load capacity” in JATMA, the “Load Capacity” in ETRTO, the maximum value given in the above-mentioned table in TRA or the like. In the case of passenger car tires, however, the standard pressure and standard tire load are defined by 180 kPa and 88% of the maximum tire load, respectively, without variation.

The maximum section width points M of the tire are points on the outer surface of the tire in the sidewall portions which are positioned at the same radial height as the maximum section width points (m) of the carcass under the normally inflated unloaded condition.

The tread edges are the axial outermost edges of the ground contacting region in the normally inflated loaded condition.

Further, the hardness of rubber means the JIS-A hardness measured with a type-A durometer according to Japanese Industrial Standard K6253.

The loss tangent refers to a value measured at a temperature of 70 degrees C., a frequency of 10 Hz, an initial tensile strain of 10%, and an amplitude of plus/minus 1%.

### BRIEF DESCRIPTION OF THE DRAWINGS

FIG. 1 is a cross sectional view of a runflat tire according to the present invention.

FIG. 2 is an enlarged cross sectional view of the sidewall portion thereof.

FIG. 3 is a partial side view of the sidewall reinforcing cord layer thereof.

FIG. 4 is a partial side view of another example of the sidewall reinforcing cord layer.

FIGS. 5 and 6 are diagrams for explaining a tire profile preferably employed in the runflat tire according to the present invention.

FIG. 7 is a diagram schematically showing a stress-elongation curve of an aramid cord used in the sidewall reinforcing cord layer.

FIG. 8 is a graph showing temperature changes of test tires during runflat performance test.

FIG. 9 is a cross sectional view for explaining the pinch cut.

### DESCRIPTION OF THE PREFERRED EMBODIMENT(S)

An embodiment of the present invention will now be described in detail in conjunction with the accompanying drawings.

In the drawings, runflat tire 1 according to the present invention comprises: a tread portion 2; a pair of sidewall portions 3; a pair of axially spaced bead portions 4 each with a bead core 5 and a bead apex 10 therein; a carcass 6 extending between the bead portions 4; a belt 7, 8 disposed radially outside the carcass in the tread portion 2; a sidewall reinforcing rubber layer 9 disposed in each of the sidewall portions 3; and a sidewall reinforcing cord layer 11 disposed in each of the sidewall portions 3.

In this embodiment, the runflat tire 1 is a radial tire for passenger cars used with a standard wheel rim, and the inner surface of the tire is covered with an innerliner 15 made of an air-impermeable rubber compound to be used without a tire tube. Aside from passenger car tires, the present invention can be applied to various tires for sport-utility vehicles, light trucks and the like. In any case, the present invention is suitably applied to pneumatic tires having an aspect ratio of not more than 65%, more suitably not more than 50%, but not less than 20%.

The above-mentioned belt comprises a breaker 7 and optionally a band 8.

The breaker 7 is disposed on the crown portion of the carcass 6 in the tread portion 2. The breaker 7 is composed of at least two, in this example only two cross plies 7A and 7B of parallel cords laid at an angle of from 10 to 35 degrees with respect to the tire equator C.

The band 8 is disposed on the radially outside of the breaker 7 so as to cover at least the edge portions of the breaker. The band 8 is composed of at least one ply of spiral windings of at least one cord or at least one ply of parallel cords. In either case, the cord angle has a small value of not more than 10 degrees, preferably not more than 5 degrees with respect to the tire equator. For the band cords, organic fiber cords are used. The band 8 can be formed by splicing the ends of a strip of rubberized parallel cords. But, in this embodiment, the band 8 is formed by spirally winding one or more cords which are embedded in raw rubber in the form of a tape.

The belt width BW as measured in the tire axial direction between the axial edges 7e of the breaker 7 (in this example, those of the widest radially innermost ply 7A) is preferably set in a range of from 0.70 to 0.95 times the maximum tire section width SW. The maximum tire section width SW is the axial distance between the maximum section width points M of the tire under the normally inflated unloaded condition.

As the sidewall reinforcing rubber layers 9 inevitably increase the tire weight, in order to compensate the weight increase, there is used a light-weight carcass 6 which is composed of a single ply 6A of cords arranged radially at an angle in a range of from 75 to 90 degrees (in this example 90 degrees) with respect to the tire equator C.

For the carcass cords, organic fiber cords, e.g. polyester, rayon, aromatic polyamide and the like can be used. In particular, rayon cords or aramid cords, especially aramid cords are preferred.

In this embodiment, steel cords are not used except for steel wires wound as the bead cores 5, not to disturb or block electromagnetic signals of sensors or devices mounted on the tire utilized in various systems, e.g. a tire pressure monitoring system and the like.

The carcass ply 6A is extended between the bead portions 4 through the tread portion 2 and the sidewall portions 3, and turned up around the bead core 5 in each of the bead portions from the inside to outside of the tire so as to form a pair of turnup portions 6b and a main portion 6a therebetween.

Between the main portion 6a and each of the turnup portions 6b, there is disposed the bead apex 10 made of a hard rubber having a JIS-A hardness of from 65 to 95, preferably 70 to 95. The bead apex 10 extends radially outwardly from the radially outside of the bead core 5, while gradually decreasing the thickness. If the height ha of the bead apex 10 is too small, a large bending stress concentrates between the bead portion 4 and sidewall portion 3 during runflat operation. Therefore, the runflat durability is liable to deteriorate. If the height ha is too large, the ride comfort is deteriorated and the tire weight increases. Therefore, the radial height ha is set in a range of from 10 to 45%, preferably 25 to 40% of the tire section height H, each measured from the bead base line BL.

The turnup portion 6b extends radially outwardly from the bead portion, along the axially outer surface of the bead apex 10, beyond the maximum section width point M or m and terminates before the axial edge 7e of the belt 7. The radially outer end 6be of the turnup portion 6b is at a distance S of at least 5 mm, preferably 5 to 15 mm when measured along the carcass ply main portion from a normal line E drawn to the outline (outer surface) of the tire from the belt edge 7e. If the distance S is less than 5 mm, the bending deformation concentrates between the belt edge and carcass edge, and damage such as edge separation becomes very liable to occur.

In each of the sidewall portions 3, the sidewall reinforcing rubber layer 9 is disposed along the axially inside of the carcass 6.

The hardness of the sidewall reinforcing rubber layer 9 is not less than 65, preferably not less than 70, more preferably not less than 74 to support the tire load during runflat operation. But, not to deteriorate the ride comfort during normal running, the hardness is at most 99, preferably not more than 90.

The loss tangent tan (delta) of the sidewall reinforcing rubber layer 9 is 0.03 to 0.08, preferably 0.03 to 0.06 to control heat generation.

For such sidewall reinforcing rubber layer 9, a rubber compound containing diene rubber as its base rubber is preferably used. As to the diene rubber, natural rubber, isoprene rubber, styrene butadiene rubber, butadiene rubber, chloroprene rubber and acrylonitrile butadiene rubber can be used alone or in combination.

The sidewall reinforcing rubber layer 9 curves along the carcass 6 and tapers from its central portion 9A to the radial inner end 9i and also to the radial outer end 9o. Thus, the layer 9 has a crescent-shaped cross sectional shape. The maximum thickness T occurs around the maximum section width point (m). The maximum thickness T is not less than 5 mm, preferably not less than 8 mm, but not more than 20 mm, preferably not more than 15 mm. The thickness of the layer 9 gradually decreases from the maximum thickness T to zero at the radially inner and outer ends 9i and 9o.

The radially inner end 9i is positioned radially inward of the radially outer end 10t of the bead apex 10 and radially outward of the radially outer end of the bead core 5, therefore, the sidewall reinforcing rubber layer 9 and the bead apex 10 are overlapped so as not to form a weak point against the bending deformation in a region from the sidewall portion 3 to the bead portion 4.

The radially outer end 9o is, on the other hand, positioned in the tread portion 2, preferably axially inward of the belt edge 7e so that the sidewall reinforcing rubber layer 9 and the belt 7 are overlapped each other for the same reason as above.

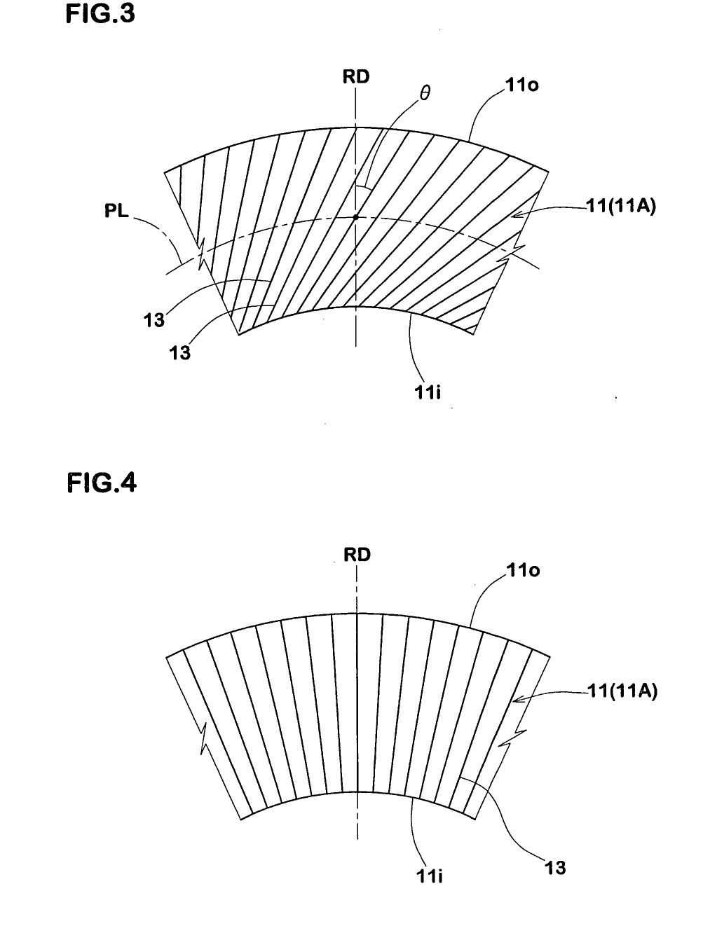

On the axially outside of the carcass ply main portion 6a in each of the sidewall portions, the sidewall reinforcing cord layer 11 is disposed. The layer 11 is composed of at least one ply, in this embodiment only one ply 11A, of aramid cords 13 arranged radially at an angle (theta) of from 0 to 45 degrees preferably 0 to 40 degrees with respect to the radial direction as shown in FIGS. 3 and 4.

The radially outer end 11o of the sidewall reinforcing cord layer 11 is secured between the belt 7 and the carcass ply main portion 6a because this region is rigid and these layers are relatively steady even at runflat operation.

The overlap AL between the sidewall reinforcing cord layer 11 and the belt 7 is not less than 5 mm, preferably not less than 10 mm, more preferably not less than 15 mm, but not more than 40 mm, preferably not more than 30 mm, more preferably not more than 25 mm in the axial direction of the tire.

The radially inner end 11i of the sidewall reinforcing cord layer 11 is also secured between the carcass ply main portion 6a and the bead apex 10. Preferably, the inner end 11i is located at a position lower than the rim flange height and near the bead core because this region is rigid and steady even at runflat operation.

The overlap RL between the sidewall reinforcing cord layer 11 and bead apex 10 is not less than 5 mm, preferably not less than 10 mm, more preferably not less than 15 mm, but not more than 50 mm in the tire radial direction.

Preferably, the radially inner end 11i of the sidewall reinforcing cord layer 11 and the radially inner end 9i of the sidewall reinforcing rubber layer 9 are placed at near positions to each other, and the radial distance D therebetween is set in a range of not more than 10 mm. In this embodiment, the inner end 11i is positioned at almost same height as that of the radially inner end 9i.

Preferably, the aramid cord 13 for the sidewall reinforcing cord layer 11 has a structure of 800 to 2200 dtex/2, preferably 1000 to 2100 dtex/2, and the cord twist and strand twist are in the range of from 30 to 70, preferably 45 to 65 turns/10 cm cord length.

The cord count in the sidewall reinforcing cord layer 11 is not less than 35 ends/5 cm width, preferably not less than 40 ends/5 cm, more preferably not less than 45 ends/5 cm, but not more than 65 ends/5 cm, preferably not more than 60 ends/5 cm, more preferably not more than 55 ends/5 cm.

It is preferable that the cord count of the sidewall reinforcing cord layer 11 is more than the cord count of the carcass ply 6A.

If the twist number of the aramid cord 13 is less than 30 turns/10 cm, a necessary elongation at the time of a light load can not be obtained. As a result, ride comfort during normal running is deteriorated. If the twist number is more than 70 turns/10 cm, the elongation at the time of a heavy load increases, and it is difficult to control the folding of the sidewall portion 3.

If the aramid cord 13 is thinner than 800 dtex/2, the strength becomes insufficient to prevent pinch cuts. If the aramid cord 13 is thicker than 2200 dtex/2, the ride comfort during normal running is liable to deteriorate, and the tire weight is unfavorably increased.

If the cord count of the aramid cords 13 is less than 35 ends/5 cm, it is difficult to fully reinforce the sidewall portion 3. If the cord count is more than 60 ends/5 cm, the ride comfort during normal running is greatly deteriorated.

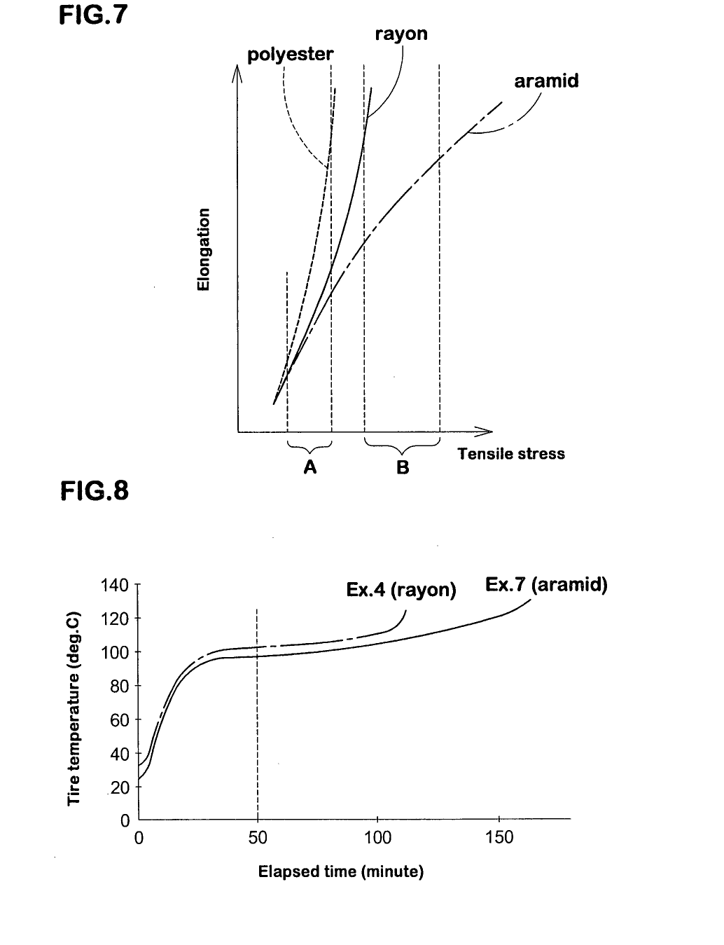

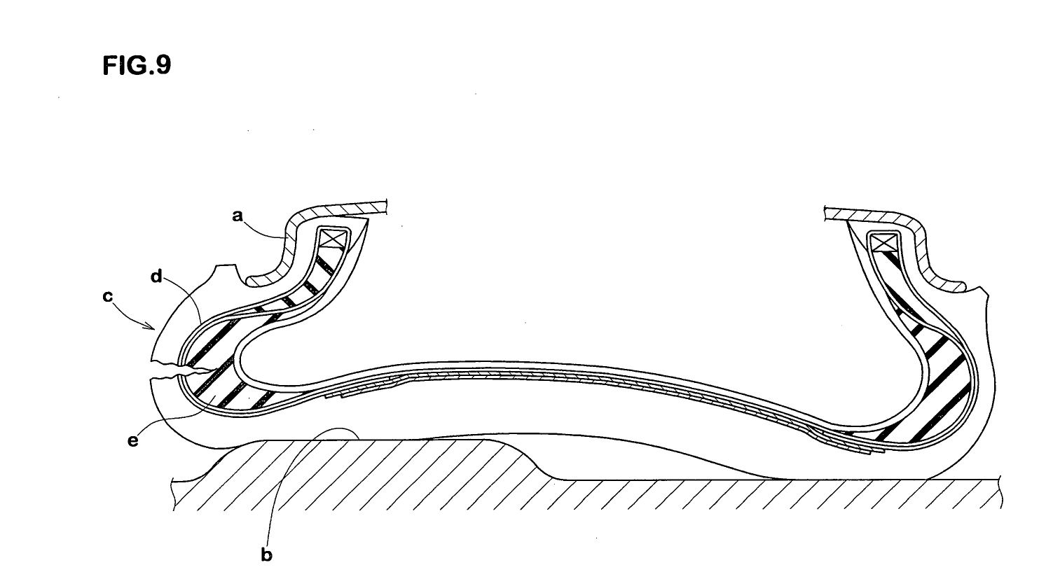

By the above-described cord structure, as schematically shown in FIG. 7, the aramid cord 13 shows a relatively low modulus against tensile stresses during normal running, but a relatively high modulus against tensile stresses during runflat operation. In FIG. 7, “A” is a typical range of the tensile stresses during normal running, and “B” is a typical range of the tensile stresses during runflat operation.

In this figure, stress-elongation curves of rayon and polyester cords having the same structure as the aramid cord are also plotted. As seen in this figure, rayon cords and polyester cords having the structure as limited as above are unusable in view of the elongation and strength.

As the sidewall reinforcing cord layer 11 is sandwiched between the carcass ply main portion 6a and carcass ply turnup potion 6b, and thereby a strong three-layered construction is formed immediately axially outside the sidewall reinforcing rubber layer 9. As a result, the large tensile stress during runflat operation is mainly occured in the three-layered construction and, in the sidewall reinforcing rubber layer 9, compressive stress is occured. Therefore, against the folding deformation caused when the pressure is greatly reduced, the sidewall portion can strongly resist, without deteriorating the ride comfort during normal running because the aramid cords are provided with a specific structure which shows the lower modulus range “A” and high modulus range “B” optimized for runflat operation.

The sidewall reinforcing cord layer 11 may be composed of a plurality of plies, but not to increase the tire weight a singe-ply structure is preferably employed.

In order to decrease the size of the sidewall reinforcing rubber layer 9, it is preferable that the tire profile TL from the tire equator CP to a position beyond the tread edge is defined by a gradually decreasing multi radius or variable radius of curvature.

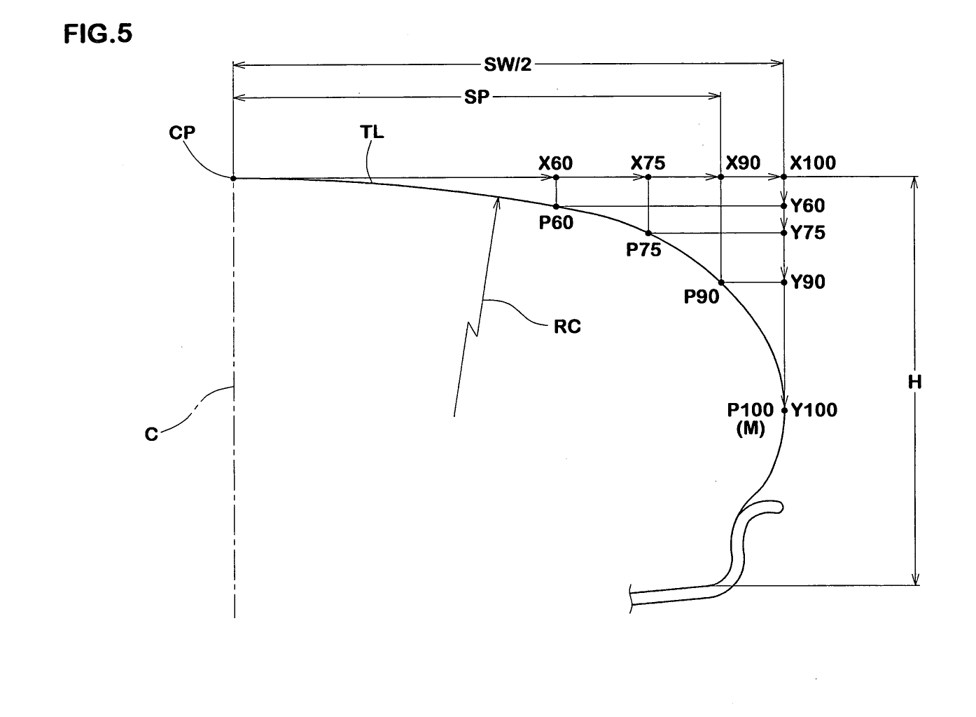

FIG. 5 shows an example of the tire profile TL under the normally inflated unloaded state. This profile TL, which is proposed in Japanese Patent No. 2994989 (Publication No. JP-A-8-337101), is suitable for the runflat tire 1 according to the present invention.

The tire profile TL has a multi radius or a variable radius of curvature RC which gradually decreases from the tire equator point CP to a point P90 on each side thereof so as to satisfy the following conditions:
0.05<Y60/H=<0.1
0.1<Y75/H=<0.2
0.2<Y90/H=<0.4
0.4<Y100/H=<0.7,
wherein
“H” is the tire section height, and “Y60”, “Y75”, “Y90” and “Y100” are radial distances from the tire equator point CP to a point P60, a point P75, the point P90 and a point P100, respectively. The points P60, P75, P90 and P100 are defined on each side of the tire equator point CP as the points on the profile TL spaced apart from the tire equator point CP by axial distances of 60%, 75%, 90% and 100%, respectively, of one half of the maximum tire section width SW between the positions M.

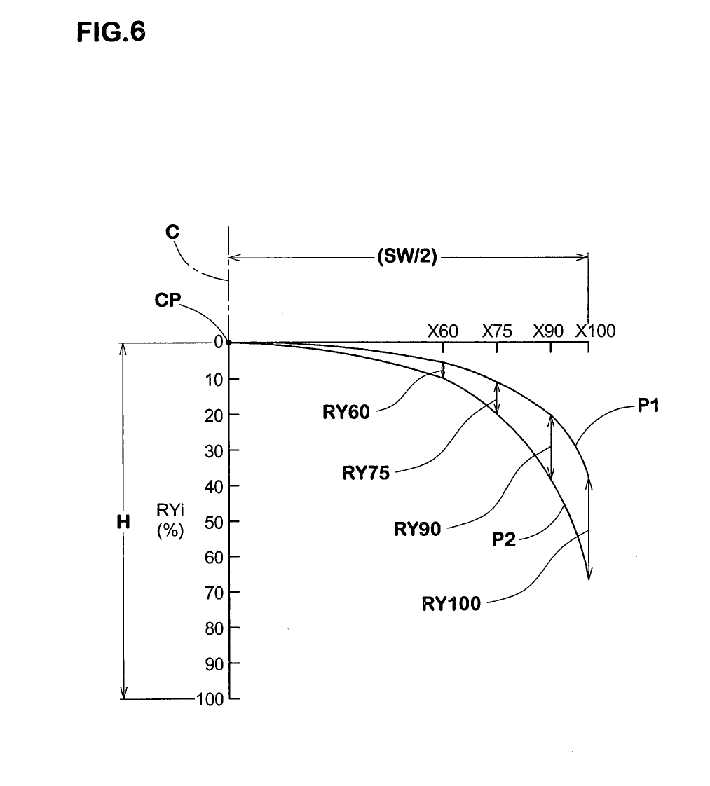

FIG. 6 is a graph showing the range RY60 for the value Y60/H, the range RY75 for the value Y75/H, the range RY90 for the value Y90/H and the range RY100 for the value Y100/H, wherein the curve P1 is an envelope of the lower limits of the ranges, and the curve P2 is an envelope of the upper limits of the ranges. The profile TL lies between the curves P1 and P2.

In the tire 1 having such special profile, when compared with the conventional profiles, the sidewall reinforcing rubber layer 9 is decreased in the dimension in the radial direction, and therefore, a significant weight reduction is possible. Further, the ground contacting width is decreased, and the ground contacting length is increased. As a result, tire running noise can be reduced, and the resistance to hydroplaning is improved. Furthermore, the vertical spring constant of the tire decreases to improve the ride comfort.

Comparison Tests

Radial tires of size 245/45R18 (Rim size 18×8J) for passenger cars were prepared and tested for the runflat performance, resistance to pinch cut, steering stability, ride comfort and tire uniformity.

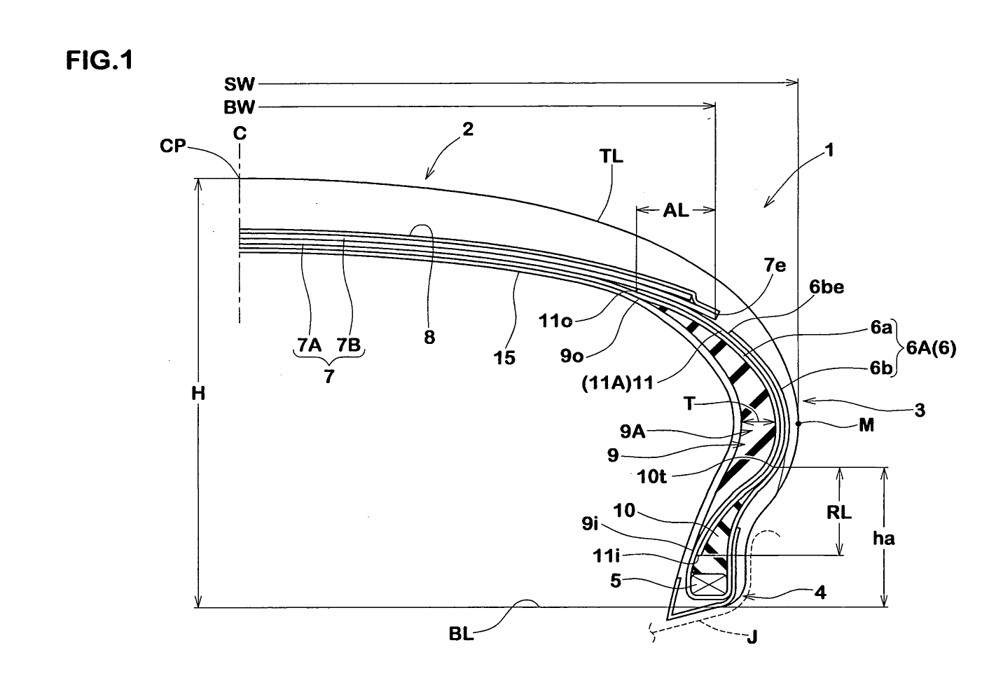

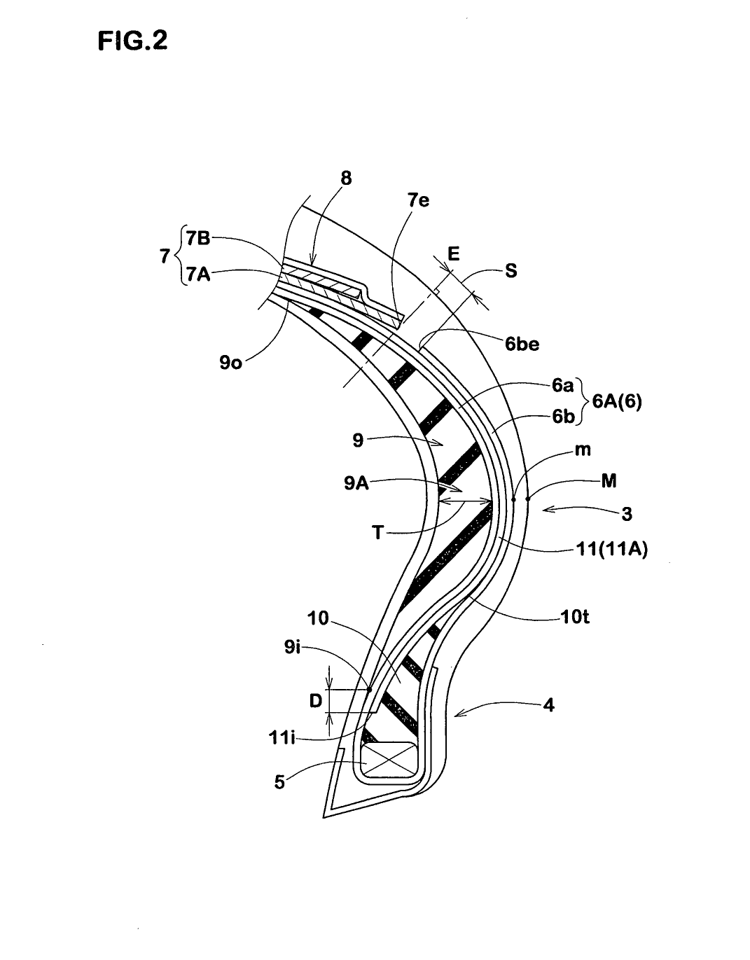

The test tires had the basic structure shown in FIGS. 1 to 3, which includes the breaker 7 composed of two cross breaker plies 7A and 7B of steel cords, the band 8 made of spirally wound aramid cords, and the bead apex 10 having a radial height ha of 35 mm. In the test tires, the maximum thickness T of the sidewall reinforcing rubber layer was changed, but other specifications, e.g. the radial extent and position and the rubber composition (JIS durometer type A hardness: 78) were common to all.

The following profiles A and B were used as the above-mentioned tire profile TL.

| Tire profile | A | B |
|---|---|---|
| Y60/H | 0.06 | 0.09 |
| Y75/H | 0.08 | 0.14 |
| Y90/H | 0.19 | 0.37 |
| Y100/H | 0.57 | 0.57 |

Runflat Performance Test

The tire was mounted on a standard wheel rim and then the air valve core was removed from the wheel rim to deflate the tire. Using a tire test drum, the deflated tire was run at a speed of 80 km/hr, applying a tire load of 4.14 kN (load index 65%). The test was carried out at room temperature of 38+/−2 degrees C. until the tire was broken to obtain the runflat distance. The results are indicated in Table 1 by an index based on Ex. 1 being 100. The larger the value, the better the runflat performance.

Pinch Cut Resistance Test

A steel pipe of 110 mm height×100 mm width×1500 mm length having a rectangular cross sectional shape was fixed to on the test course. A Japanese 4300cc FR car provided on the front right wheel with the deflated test tire was ran over the steel pipe repeatedly so as to intersect at an angle of 15 degrees with respect to the longitudinal direction of the steel pipe. The intersecting speed was increased at a step of 1 km/hr from the initial speed of 15 km/hr, and the speed at which a pinch cut was occured in the sidewall portion was measured. The results are indicated in Table 1 by an index based on Ex. 1 being 100, wherein the larger the value, the higher the resistance.

Steering Stability and Ride Comfort Tests

The test car provided on the four wheels with identical test tires (inflated to 230 kPa) was run on a dry asphalt road, and the test driver evaluated steering stability based on cornering response, grip and the like. Further, the test car was run on rough roads (including asphalt road, stone-paved road and graveled road) and the test driver evaluated the ride comfort, based on harshness, damping, thrust-up, etc. The test results are indicated in Table 1 by an index based on Ex. 1 being 100. The larger the index, the better the performance.

Tire Uniformity Test

According to JASO C607:2000 “Test Procedures for Automobile Tire Uniformity”, twenty samples per test tire were measured for the radial force variation (RFV), and the mean values was computed. The results are indicated in Table 1 by an index based on Ex. 1 being 100, wherein the larger the value, the better the uniformity.

Tire Mass

The mass of the test tire was measured and indicated in Table 1 by an index based on Ex. 1 being 100.

From the test results, it was confirmed that the resistance to pinch cut and runflat performance can be improved without a significant increase of the tire mass.

In FIG. 8, the temperature change of the sidewall portion during the runflat performance test is shown. After the lapse of 50 minutes from the start of test, the temperature of Ex. 7 became about 5 degrees lower than Ex. 4. Further, the running time to breakage of Ex. 7 became longer than Ex. 4. The only difference between Ex. 7 and Ex. 4 was the carcass cord material. From this fact, it is understandable that the aramid carcass is preferable to the rayon carcass.

TABLE 1

| Tire | Ref. 1 | Ref. 2 | Ref. 3 | Ref. 4 | Ref. 5 | Ref. 6 | Ex. 1 | Ex. 2 |
|---|---|---|---|---|---|---|---|---|
| Tire profile | A | A | A | A | A | A | A | A |
| Carcass | | | | | | | | |
| Number of ply | 1 | 1 | 1 | 1 | 1 | 1 | 1 | 1 |
| Cord material | rayon | rayon | aramid | aramid | rayon | rayon | rayon | rayon |
| Cord structure (dtex/2) | 1840 | 1840 | 1100 | 1100 | 1100 | 1100 | 1100 | 1100 |
| Cord count/5 cm | 51 | 51 | 49 | 49 | 49 | 49 | 49 | 49 |
| Turnup portion | | | | | | | | |
| Outer end S (mm)*1 | −15 | +10 | +10 | −15 | +10 | +10 | +10 | +10 |
| Sidewall reinforcing cord layer | | | | | | | | |
| Number of ply | 0 | 0 | 0 | 0 | 1 | 1 | 1 | 1 |
| Cord material | — | — | — | — | rayon | steel | aramid | aramid |
| Cord angle (deg.) | — | — | — | — | 45 | 45 | 45 | 45 |
| Cord count/5 cm | — | — | — | — | 48 | 30 | 55 | 55 |
| Cord twist (turn/10 cm) | — | — | — | — | 48 | 30 | 55 | 55 |
| Cord structure (dtex/2) | — | — | — | — | 1840 | 840 | 1100 | 1100 |
| Overlap AL(mm) | — | — | — | — | 20 | 20 | 20 | 20 |
| Overlap RL(mm) | — | — | — | — | 25 | 25 | 25 | 25 |
| Sidewall reinforcing rubber layer | | | | | | | | |
| Maximum thickness T(mm) | 10.0 | 10.0 | 10.0 | 10.0 | 10.0 | 10.0 | 10.0 | 9.0 |
| Tire mass (index) | 100 | 102 | 102 | 100 | 98 | 96 | 98 | 100 |
| Runflat distance (index) | 100 | 90 | 110 | 115 | 95 | 102 | 103 | 100 |
| Pinch cut resistance (index) | 100 | 85 | 101 | 110 | 90 | 103 | 102 | 101 |
| Steering stability (index) | 100 | 98 | 98 | 100 | 100 | 98 | 100 | 100 |
| Ride comfort (index) | 100 | 105 | 105 | 100 | 100 | 95 | 99 | 105 |
| Tire uniformity (index) | 100 | 109 | 109 | 100 | 108 | 105 | 108 | 109 |

| Tire | Ex. 3 | Ex. 4 | Ex. 5 | Ex. 6 | Ex. 7 | Ex. 8 | Ex. 9 |
|---|---|---|---|---|---|---|---|
| Tire profile | B | B | A | A | B | A | A |
| Carcass | | | | | | | |
| Number of ply | 1 | 1 | 1 | 1 | 1 | 1 | 1 |
| Cord material | rayon | rayon | rayon | aramid | aramid | rayon | rayon |
| Cord structure (dtex/2) | 1100 | 1100 | 1100 | 1100 | 1100 | 1100 | 1100 |
| Cord count/5 cm | 49 | 49 | 49 | 49 | 49 | 49 | 49 |
| Turnup portion | | | | | | | |
| Outer end S (mm)*1 | +10 | +10 | +10 | +10 | +10 | +10 | +10 |
| Sidewall reinforcing cord layer | | | | | | | |
| Number of ply | 1 | 1 | 2 | 1 | 1 | 1 | 1 |
| Cord material | aramid | aramid | aramid | aramid | aramid | aramid | aramid |
| Cord angle (deg.) | 45 | 45 | 45 | 45 | 45 | 45 | 45 |
| Cord count/5 cm | 55 | 55 | 55 | 55 | 55 | 55 | 55 |
| Cord twist (turn/10 cm) | 55 | 55 | 55 | 55 | 55 | 30 | 70 |
| Cord structure (dtex/2) | 1100 | 1100 | 1100 | 1100 | 1100 | 1100 | 1100 |
| Overlap AL(mm) | 20 | 20 | 20 | 20 | 20 | 20 | 20 |
| Overlap RL(mm) | 25 | 25 | 25 | 25 | 25 | 25 | 25 |
| Sidewall reinforcing rubber layer | | | | | | | |
| Maximum thickness T(mm) | 10.0 | 9.0 | 9.0 | 9.0 | 9.0 | 10.0 | 10.0 |
| Tire mass (index) | 106 | 108 | 95 | 98 | 106 | 98 | 98 |
| Runflat distance (index) | 113 | 109 | 107 | 104 | 116 | 105 | 100 |
| Pinch cut resistance (index) | 102 | 101 | 108 | 104 | 104 | 102 | 102 |
| Steering stability (index) | 100 | 100 | 102 | 101 | 101 | 102 | 99 |
| Ride comfort (index) | 110 | 115 | 96 | 98 | 108 | 96 | 100 |
| Tire uniformity (index) | 110 | 110 | 100 | 100 | 109 | 105 | 110 |

*1Plus (+) sign denotes the end 6be on the axially outside of the line E
Minus (−) sign denotes the end 6be on the axially inside of the line E

1. A runflat tire comprising
a tread portion,
a pair of sidewall portions,
a pair of bead portions each with a bead core therein,
a carcass extending between the bead portions through the tread portion and sidewall portions,
the carcass consisting of a single ply of organic fiber cords extending between the bead portions and turned up around the bead core in each said bead portion from the inside to the outside of the tire to form a pair of carcass ply turnup portions and a carcass ply main portion therebetween,
a belt disposed radially outside a crown portion of the carcass,
a sidewall reinforcing rubber layer disposed axially inside the carcass in each said sidewall portion and having a crescent-shaped cross sectional shape,
a sidewall reinforcing cord layer of aramid cords disposed in each said sidewall portion along the axially outer surface of the carcass ply main portion, and
each said carcass ply turnup portion extending radially outwardly beyond a maximum section width point of the carcass and terminated before the axial edge of the belt.

2. The runflat tire according to claim 1, wherein
the radially outer end of the sidewall reinforcing cord layer is positioned between the carcass ply main portion and the belt, and
the radial inner end of the sidewall reinforcing cord layer is positioned between the carcass ply main portion and a bead apex rubber, the bead apex rubber disposed between the carcass ply turnup portion and the carcass ply main portion.

3. The runflat tire according to claim 1, wherein
the sidewall reinforcing cord layer is composed of a single ply of the aramid cords at a cord count of from 35 to 65 ends/5 cm ply width, and the aramid cords each have a cord structure of 800 to 2200 dtex/2 and a twist number of from 30 to 70 turn/10 cm cord length.

4. The runflat tire according to claim 2, wherein
the sidewall reinforcing cord layer is composed of a single ply of the aramid cords at a cord count of from 35 to 65 ends/5 cm ply width, and the aramid cords each have a cord structure of 800 to 2200 dtex/2 and a twist number of from 30 to 70 turn/10 cm cord length.

5. The runflat tire according to claim 1, wherein the organic fiber cords of the carcass ply are rayon cords.

6. The runflat tire according to claim 1, wherein the organic fiber cords of the carcass ply are aramid cords.

7. The runflat tire according to claim 1, which is provided with a profile defined by a multi-radius of curvature or alternatively a variable radius of curvature gradually decreasing from the tire equator to a position axially outwardly beyond each tread edge.

8. The runflat tire according to claim 2, wherein
the organic fiber cords of the carcass ply are rayon cords.

9. The runflat tire according to claim 3, wherein
the organic fiber cords of the carcass ply are rayon cords.

10. The runflat tire according to claim 4, wherein
the organic fiber cords of the carcass ply are rayon cords.

11. The runflat tire according to claim 2, wherein
the organic fiber cords of the carcass ply are aramid cords.

12. The runflat tire according to claim 3, wherein
the organic fiber cords of the carcass ply are aramid cords.

13. The runflat tire according to claim 4, wherein
the organic fiber cords of the carcass ply are aramid cords.
